(19) United States
(12) Patent Application Publication
(10) Pub. No.: US 2026/0260288 A1
(43) Pub. Date: Sep. 3, 2026

(54) AUTOMATED SYSTEM FOR TRANSACTION QUEUEING AND FORWARDING TO CORE BANKING SYSTEM TO PREVENT TECHNICAL FAILURES

(71) Applicant: DTBX INNOVATE INDIA PRIVATE LIMITED, Mumbai (IN)

(72) Inventors: Harshal Dilip Doshi, Mumbai (IN); Satish Krishnaswamy, Mumbai (IN); Vatsal H Sura, Ahmedabad (IN); Abhishek Vichhi, Jamnagar (IN)

(21) Appl. No.: 19/553,236

(22) Filed: Feb. 28, 2026

(30) Foreign Application Priority Data
Feb. 28, 2025 (IN) 202521017803

(51) Int. Cl. G06Q 40/02; G06N 20/00

(52) U.S. Cl. CPC G06Q 40/023; G06N 20/00

(57) ABSTRACT

Embodiments herein provide an automated system 100 for transaction queueing and forwarding to a core banking system (CBS) 110 to prevent technical failures. The system involves (i) obtain base thread pool size for CBS 110 based on the CBS 110 configuration, (ii) determine plurality of transaction control parameters including average response time, incoming transactions per second (TPS), required TPS, and base thread pool size, (iii) evaluate dynamic thread pool size of CBS 110 based on the determined transaction control parameters, (iv) train an AI model using training parameters including concurrent requests, response times of transactions, TPS values, and thread utilization ratios, (v) dynamically adjust the thread pool size using trained AI model 116 based on CBS 110 load variations, and (vi) manage transactions through multi-zone queues including primary queue 402A, high-priority queue 402B, and dead queue 402C, (vii) forward the transaction from the high priority queue 402B for execution.

### BACKGROUND

### Technical Field

The embodiments herein generally relate to an artificial intelligence, and more particularly, an automated system for transaction queueing and forwarding to core banking system to prevent technical failures.

### Description of the Related Art

Volumes of digital transactions are increasing at a rapid rate in Banking industry. Each payment system is allocated a finite number of physical resources (e.g., Server Memory, CPU Cores, Operating System, etc.) in each bank as per their own size and budget. Multiple payment systems in bank work in silos and face system overcapacity or outage resulting in Transaction Declines. Some examples of such siloed payment systems include Bank Payment Systems like UPI/IMPS/NEFT/RTGS/Debit card/Internet banking/BBPS/Branch banking/clearing and others.

Existing digital payment systems, including real-time electronic payment platforms, rely on predefined transaction processing constraints that require each transaction to be completed within a specified time period. The performance of such systems is highly dependent on the availability and efficiency of underlying transaction processing resources. During periods of high transaction volume, traffic surges, or uneven load distribution, existing systems may experience resource congestion and processing delays. As a result, transactions may fail to complete within the required time period, leading to technical timeouts, transaction declines, or temporary rejection of new transaction requests, even though backend processing may still be ongoing.

Further, existing systems are often unable to efficiently adapt to sudden spikes in demand or partial system unavailability. Scheduled or unscheduled maintenance of core banking or payment infrastructure can disrupt transaction processing, and such downtime is typically not visible to end users at the time of transaction initiation. This lack of visibility can result in repeated transaction attempts and increased system load. Additionally, inefficient resource allocation and limited transaction offloading mechanisms in existing systems can increase processing latency under high traffic conditions. This leads to degraded system performance, reduced transaction success rates, and a poor overall user experience, thereby highlighting the need for improved mechanisms to manage transaction load, timing constraints, and system availability. Additionally, the existing systems for transactions offloading struggle with scalability during peak periods, often resulting in system overloads that cause delays or transaction declines. Scheduled downtime for maintenance can disrupt services, and customers are typically unaware of these outages. resource management can be inefficient, leading to poor system performance, while increased latency during high traffic further affects the user experience.

Another approach that cannot handle sudden surges in transaction volume in real time is a significant limitation, resulting in extended periods of service degradation or even complete downtime. During peak traffic, the lack of scalability and quick responsiveness exacerbates these issues, leading to performance bottlenecks, and transaction declines.

Accordingly, there remains a need for improving the success rate of transactions and mitigate the impact of system overcapacity or outages that result in declined transactions.

### SUMMARY

In view of the foregoing, embodiments herein provide an automated system for transaction queueing and forwarding to a core banking system to prevent technical failures. The system includes a memory and a processor communicatively connected to the memory and configured to (1) obtain a base thread pool size for the core banking system (CBS) based on the CBS configuration for processing transactions initiated through a plurality of user devices; (2) determine a plurality of transaction control parameters, where the transaction control parameters including (i) an average response time of the CBS, (ii) incoming transactions per second (TPS), (ii) a required TPS, and (iv) the base thread pool size of the CBS; (3) evaluate a dynamic thread pool size of the CBS based on the determined transaction control parameters; (4) train an artificial intelligence (AI) model using a plurality of training parameters, where the plurality of training parameters including (i) current number of concurrent transaction requests, (ii) a current average response time of the CBS, (iii) a current TPS value, (iv) the required TPS value, or (v) a thread utilization ratio; (5) initiate processing of transactions through the CBS using the transaction queuing and forwarding server by executing an artificial intelligence (AI) model that analyses (i) the dynamic thread pool size being within a predetermined range, (ii) reduce the dynamic thread pool size by a deviation value (Δ) in proportion to current response time of the CBS when the required TPS is lower than the incoming TPS, or (iii) increase the dynamic thread pool size by the deviation value (Δ) in proportion to the current response time when the required TPS is higher than the incoming TPS, the deviation value (Δ) is determined based on the distance between the current number of concurrent transaction requests and benchmarked maximum concurrent transaction requests count defined for the CBS; (6) detect (i) a first processing zone configured to receive all incoming transactions, the transactions being placed in a primary queue and released to CBS for processing in a controlled manner based on a dynamic thread pool size, (ii) a second processing zone configured to move transactions spending more than a predetermined percentage of a permissible lifespan in the primary queue being transferred to the high priority queue, or (iii) a third processing zone configured to transfer transactions that have exceeded their permissible lifespan in the preceding queues to a dead queue; and (7) execute the transactions successfully by forwarding transactions from the second processing zone to the CBS, thereby enabling efficient and successful transaction execution and preventing technical failures.

A system and method are provided for governing transaction volumes and offloading excess transaction requests using an artificial intelligence (AI)-driven queuing and routing technique. The system is configured to monitor incoming transaction rates and available processing capacity and to regulate transaction flow to reduce processing delays and prevent transaction failures caused by technical timeout conditions. By dynamically governing and offloading transactions across available processing paths, the system improves transaction success rates during periods of high transaction volume. The system further optimizes transaction handling by selecting processing paths based on performance metrics such as latency, availability, and success probability, thereby improving processing speed and reliability. Additionally, the system supports scalability by efficiently distributing transaction loads, enables real-time adaptation to changing system conditions, and enhances resource utilization while maintaining compliance and security requirements.

In some embodiments, a TPS controller of the transaction queuing and forwarding server adjusts a transaction thread count proportionally to a thread utilization ratio of the CBS, where the thread utilization ratio is a metric indicating a number of requests processed by a processing thread per unit time, and where adjustments are incrementally performed based on dynamic load on the CBS.

In some embodiments, the dynamic load on the CBS is determined using the current response time and an average response time, where the current response time of the CBS is measured as the interval between the reception of a transaction request and the completion of the corresponding response and the average response time of the Core Banking System (CBS) is measured as the mean of the response times for a plurality of transaction requests processed by the CBS over a predetermined time interval.

In some embodiments, the base thread pool size of the CBS refers to a predefined number of threads allocated for transaction processing, and the dynamic thread pool size refers to the number of threads adjusted in response to the dynamic load on the CBS.

In some embodiments, a queue manager of the transaction queuing and forwarding server is configured to prioritize transactions based on time-sensitive parameters and Routes transactions from the second queue and the third queue, where the time-sensitive parameters including (i) financial/non-financial, (ii) Merchant Category Code (MCC), (iii) transaction amount (iv) customer category, (v) channel-wise, (vi) inward / outward, (vii) channel-wise beneficiary bank performance, (viii)a financial technology entity, (ix) transaction mode (x) beneficiary type.

In some embodiments, the AI model determines an optimal transaction forwarding, predicts a CBS overload, and derives warning levels for queuing, and routes transactions to optimize throughput and minimize transaction failures dynamically.

In some embodiments, the queuing mechanism utilizes a system-defined maximum transaction response time to maintain compliance while offloading CBS resources, where the queuing mechanism including a primary queue, a high priority queue, and a dead queue, where the primary queue receives all incoming transactions and operates on a first-in, first-out (FIFO) basis, the high priority queue arranges transactions in descending order of priority, with equal priorities following FIFO and the dead queue operates on FIFO and stores failed or unprocessed transactions.

In one aspect, a method for an automated method for transaction queueing and forwarding to a core banking system to prevent technical failures. The method includes (1) obtaining a base thread pool size for the core banking system (CBS) based on the CBS configuration for processing transactions initiated through a plurality of user devices; (2) determining a plurality of transaction control parameters, where the transaction control parameters including (i) an average response time of the CBS, (ii) incoming transactions per second (TPS), (ii) a required TPS, and (iv) the base thread pool size of the CBS; (3) evaluating a dynamic thread pool size of the CBS based on the determined transaction control parameters; (4) training an artificial intelligence (AI) model using a plurality of training parameters, where the plurality of training parameters including (i) current number of concurrent transaction requests, (ii) a current average response time of the CBS, (iii) a current TPS value, (iv) the required TPS value, or (v) a thread utilization ratio; (5) initiating processing of transactions through the CBS using the transaction queuing and forwarding server by executing an artificial intelligence (AI) model that analyses (i) the dynamic thread pool size being within a predetermined range, (ii) reduce the dynamic thread pool size by a deviation value (Δ) in proportion to current response time of the CBS when the required TPS is lower than the incoming TPS, or (iii) increase the dynamic thread pool size by the deviation value (Δ) in proportion to the current response time when the required TPS is higher than the incoming TPS, where the deviation value (Δ) is determined based on the distance between the current number of concurrent transaction requests and benchmarked maximum concurrent transaction requests count defined for the CBS; (5) detecting (i) a first processing zone configured to receive all incoming transactions, the transactions being placed in a primary queue and released to the CBS for processing in a controlled manner based on a dynamic thread pool size, (ii) a second processing zone configured to move transactions spending more than a predetermined percentage of a permissible lifespan in the primary queue being transferred to the high priority queue, or (iii) a third processing zone configured to transfer transactions that have exceeded their permissible lifespan in the preceding queues to a dead queue; and (6) executing the transactions successfully by forwarding transactions from the second processing zone to the CBS, thereby enabling efficient and successful transaction execution and preventing technical failures.

In some embodiments, the TPS controller adjusts a transaction thread count proportionally to a thread utilization ratio of the CBS, where the thread utilization ratio is a metric indicating a number of requests processed by a processing thread per unit time, and where adjustments are incrementally performed based on dynamic load on the CBS.

In some embodiments, the dynamic load on the CBS is determined using the current response time and an average response time, where the current response time of the CBS is measured as the interval between the reception of a transaction request and the completion of the corresponding response and the average response time of the Core Banking System (CBS) is measured as the mean of the response times for a plurality of transaction requests processed by the CBS over a predetermined time interval.

### BRIEF DESCRIPTION OF THE DRAWINGS

The embodiments herein will be better understood from the following detailed description with reference to the drawings, in which:

FIG. 1 illustrates a block diagram of an automated system 100 for automatically queueing and forwarding transactions to a core banking system (CBS) to prevent technical failures, according to some embodiments herein;

FIG. 2 illustrates a block diagram 200 of a transaction queueing and forwarding server 108, according to some embodiments;

FIG. 3 illustrates a block diagram 300 of a processing zone detecting module 212, according to some embodiments herein;

FIG. 4 illustrates a detailed block diagram of a queuing mechanism of the transaction queueing and forwarding server 108, according to some embodiments herein;

FIG. 5 illustrates a comparative governance response summary showing transaction processing performance without governance and with governance, according to some embodiments herein;

FIG. 6 illustrates an example user interface for configuring multiple transaction parameters and generating transaction priority scores for transaction governance, according to some embodiments herein;

FIGS. 7A-7B is a flow diagram that illustrates an automated system for transaction queueing and forwarding to a core banking system to prevent technical failures, according to some embodiments herein;

FIG. 8 is representative hardware environment for practicing the embodiments herein is depicted in FIG. 8, with reference to FIGS. 1 through 7A-7B in accordance with the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

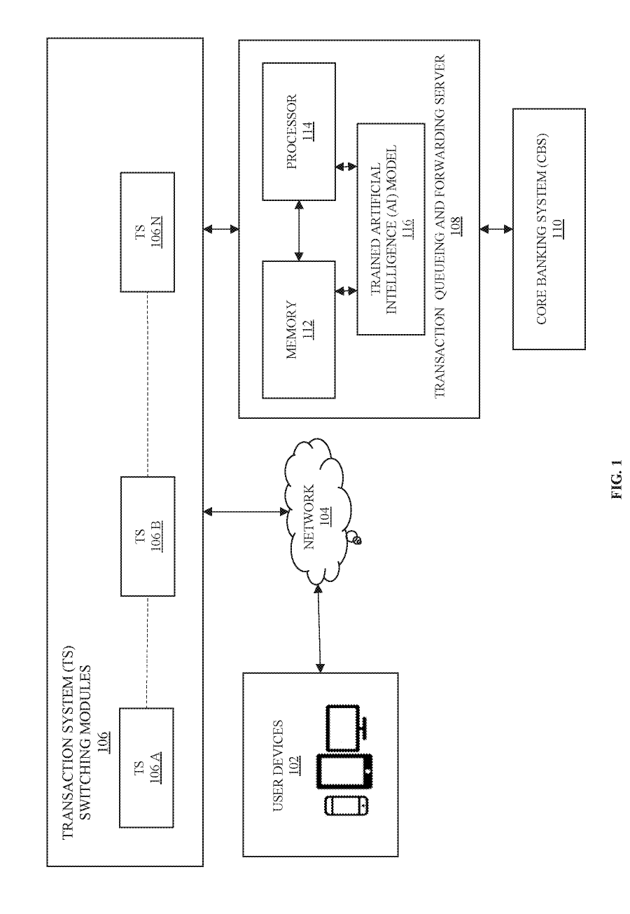

As mentioned, there remains a need for an automated system for transaction queueing and forwarding to a core banking system to prevent technical failures. Referring now to the drawings, and more particularly, FIGS. 1 through 8, where similar reference characters denote corresponding features consistently throughout the figure’s, preferred embodiments are shown.

The term “Transaction stack” refers to the collection of technologies, services, and processes involved in handling online transactions (e.g., payments). It typically includes several layers, and each layer is responsible for a different aspect of the transaction process. The transaction stack is a comprehensive system designed to facilitate smooth, secure, and efficient payment processing for online and offline transactions. The pulse rate is a metric used to evaluate the efficiency and performance of the transaction system.

The term "response time" refers to the duration it takes for the transaction system to react or provide a response after receiving a request or initiating a transaction. This response time encompasses various stages of the payment process, including authorization, processing, and confirmation.

The term “average response time” refers to the average amount of time it takes for a system to respond to a request, from the moment the request is made until the system provides an output or completes the task.

The term “thread pool size” refers to the total number of threads that can exist in the pool at a given time. This value may dynamically increase or decrease depending on the workload and system configuration.

The term “Base Thread Pool Size” refers to the minimum or initial number of threads allocated in the pool when it is initialized. It represents the baseline capacity before any scaling occurs.

The term “Transaction thread count” refers to the number of threads in a system that are currently allocated or used to process transactions concurrently.

The term “current number of concurrent transaction requests” refers to the number of active or ongoing transaction requests being processed simultaneously by the Core Banking System (CBS) at a given moment. This parameter reflects the real-time workload or processing concurrency level within the system.

The term “current average response time of the CBS” refers to the mean duration taken by the Core Banking System to respond to multiple requests within a given observation period. It represents a time-based performance metric used to evaluate the CBS’s operational efficiency during live transactions.

The term “current TPS value” refers to the number of transactions processed per second by the Core Banking System at a specific point in time. It serves as a dynamic throughput indicator of system capacity and real-time performance.

The term “required TPS value” refers to a target or threshold transactions-per-second rate that the Core Banking System is expected to achieve or maintain, based on service-level agreements (SLAs), transaction demand, or operational performance objectives.

The term “thread utilization ratio” refers to a metric indicating a number of requests processed by a processing thread per unit time.

The term “thread pool” refers to a collection of pre-created threads that can be used to execute tasks. It helps improve performance by reusing threads instead of creating new ones for each task. This reduces overhead and ensures efficient resource management in concurrent applications.

The term “benchmarked maximum concurrent transaction requests” refers to the maximum number of simultaneous transaction requests that the Core Banking System can process as determined through formal performance benchmarking. It represents a validated concurrency threshold used to assess system scalability and stability under load.

The term “channel-wise beneficiary bank performance” refers to the measurement and evaluation of transaction success rates, response times, and processing efficiency of beneficiary banks, segmented by transaction channel (such as internet banking, mobile banking, ATM, or API interface). It provides insight into the operational effectiveness of each delivery channel.

The term “financial technology entity” refers to an organization or service provider that leverages digital platforms, software applications, or data-driven solutions to deliver or enhance financial services, including but not limited to payment processing, digital lending, compliance automation, and banking system integration.

FIG. 1 illustrates a block diagram of an automated system 100 for automatically queueing and forwarding transactions to a core banking system (CBS) to prevent technical failures, according to some embodiments herein. The system 100 includes a plurality of user devices 102, a network 104, a transaction system (TS) switching modules 106A-106N, a transaction queueing and forwarding server 108, and a core banking system (CBS) 110. The transaction queueing and forwarding server 108 includes a memory 112, a processor 114, and a trained artificial intelligence (AI) model 116.

The plurality of user devices 102 are configured to initiate a plurality of transactions requests, directed towards the core banking system 110. The plurality of user devices 102 may include a mobile device, a tablet, a desktop computer, a kiosk, or a laptop. The plurality of user devices 102 generates transaction requests that includes metadata such as transaction ID, timestamp, transaction amount, channel type, customer category, transaction mode, and beneficiary details. The transaction request is transmitted to the transaction queueing and forwarding server 108 through the network 104.

The network 104 facilitates communication between the plurality of user devices 102, the transaction system (TS) switching modules 106A-106N, the transaction queueing and forwarding server 108, and the core banking system 110. The network 104 may be a wired, a wireless, or a hybrid network and may include the National Payments Corporation of India (NPCI) network infrastructure supporting systems such as UPI, IMPS, NEFT, RTGS, or AEPS. In some embodiments, the network 104 may further include the Internet, virtual private networks, or payment gateways employing secure protocols such as HTTPS and SSL/TLS.

The transaction system (TS) switching modules 106A-106N are configured to handle multiple types of payment channels and transaction flows. The transaction system (TS) switching modules 106A-106N may include NEFT, RTGS, UPI, IMPS, digital wallets, and merchant payment systems. Each transaction system (TS) switching modules 106A-106N is communicatively connected to the transaction queueing and forwarding server 108 and transmits real-time transaction information, including transaction status, processing time, and throughput statistics.

The transaction queueing and forwarding server 108 is communicatively connected to the user devices 102, the transaction system (TS) switching modules 106A-106N and the core banking system (CBS) 110 through the network 104. The transaction queueing and forwarding server 108 includes a processor 114, a memory 112, and an AI model 116. The transaction queueing and forwarding server 108 controls the forwarding of transactions, performs queue prioritization, evaluates dynamic load on the core banking system (CBS) 110, and executes AI-driven thread pool management to optimize system performance and prevent transaction failures.

The transaction queueing and forwarding server 108 is configured to obtain a base thread pool size for the core banking system (CBS) 110 based on the CBS configuration. The transaction queueing and forwarding server 108 further determines a plurality of transaction control parameters, including (i) an average response time of the core banking system (CBS) 110, (ii) an incoming transactions per second (TPS) rate, (iii) a required TPS value, and (iv) the base thread pool size of the core banking system (CBS) 110. The incoming transaction rate corresponds to the transaction processing load experienced by the system at a particular time.

The processor 114 of the transaction queueing and forwarding server 108 is configured to evaluate a dynamic thread pool size of the CBS 110 based on the determined transaction control parameters. The dynamic thread pool size represents the number of threads adjusted in real time according to the dynamic load experienced by the core banking system (CBS) 110.

The transaction queueing and forwarding server 108 trains an AI model using a plurality of training parameters. The training parameters include (i) a current number of concurrent transaction requests, (ii) a current average response time of the CBS 110, (iii) a current TPS value, (iv) a required TPS value, and (v) a thread utilization ratio.

The trained AI model 116 is configured to analyse CBS load conditions and predict optimal transaction throughput parameters. The trained AI model 116 determines whether the dynamic thread pool size is within a predefined range. If the required TPS is lower than the incoming TPS, the trained AI model 116 dynamically reduces the thread pool size by a deviation value (Δ) proportional to the current response time of the CBS 110. Conversely, when the required TPS is higher than the incoming TPS, the trained AI model 116 increases the thread pool size by the deviation value (Δ). The deviation value (Δ) is determined based on the distance between the current number of concurrent transaction requests and benchmarked maximum concurrent transaction requests count defined for the CBS 110.

The transaction queueing and forwarding server 108 further includes a transaction processing zone controller configured to manage multi-level queues for efficient processing. The processing zones include (a) a first processing zone, where all incoming transactions are received and placed in a primary queue, (b) a second processing zone, wherein transactions spending more than a predetermined percentage of their permissible lifespan in the primary queue are transferred to a high-priority queue, and (c) a third processing zone, where transactions that have exceeded their permissible lifespan are moved to a dead queue. The transaction queueing and forwarding server 108 execute the transactions successfully by forwarding the transactions from the second processing zone to the CBS.

The automated system 100 for transaction queueing and forwarding provides several technical advantages, including AI-based adaptive thread pool management, dynamic load prediction, and CBS 110 performance stabilization. The system ensures optimal utilization of computing resources through intelligent regulation of transaction flow and dynamic adjustment of processing threads. The multi-tier queue prioritization mechanism ensures fair and efficient processing of transactions based on predefined parameters while maintaining compliance with system-defined maximum response times. The system reduces transaction rejection and timeout rates and enhances overall reliability, scalability, and throughput of the CBS 110. The coordinated operation of the transaction queueing and forwarding server 108, trained AI model 116, and CBS 110 ensures continuous, stable, and efficient transaction processing even during peak transaction periods.

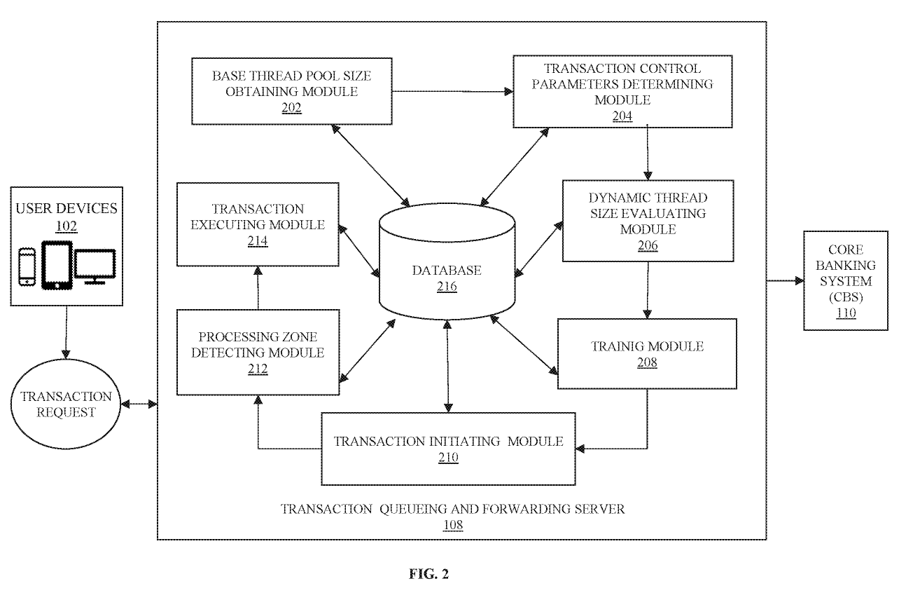

FIG. 2 illustrates a block diagram 200 of a transaction queueing and forwarding server 108, according to some embodiments. The transaction queueing and forwarding server 108 includes a base thread pool size obtaining module 202, a transaction control parameter determining module 204, a dynamic thread size evaluating module 206, a training module 208, a transaction initiating module 210, a processing zone detecting module 212, a transaction executing module 214 and database 216.

The transaction queueing and forwarding server 108 is configured to intelligently manage, queue, and forward transactions initiated by the plurality of user devices 102 to the CBS 110, in order to prevent transaction failures and maintain continuous optimized throughput. The transaction queueing and forwarding server 108 includes multiple modules that operate in coordination to achieve dynamic thread management and intelligent transaction forwarding. Each of the modules performs specific operations contributing to stable and efficient CBS 110 utilization.

The base thread pool size obtaining module 202 is configured to obtain a base thread pool size associated with the CBS 110. The base thread pool size represents the predefined number of concurrent processing threads available for handling incoming transactions under normal operating conditions. The base thread pool size obtaining module 202 retrieves this information from the CBS configuration files or administrative settings. For example, if the CBS 110 is designed to process 800 transactions per second with 200 active threads, the base thread pool size obtaining module 202 records “200” as the base thread pool size, forming a baseline reference for dynamic scaling during runtime.

The transaction control parameters determining module 204 determines a set of transaction control parameters essential for evaluating CBS performance and processing capacity. The parameters include (i) an average response time of the CBS 110, (ii) incoming transactions per second (TPS), (iii) a required TPS value, and (iv) the base thread pool size obtained by the base thread pool size obtaining module 202. The transaction control parameters determining module 204 continuously monitors real-time CBS performance metrics and updates these parameters to provide input data for adaptive scaling and queue regulation.

The dynamic thread size evaluating module 206 evaluates a dynamic thread pool size based on the transaction control parameters identified by the transaction control parameters determining module 204. The dynamic thread pool size of CBS means that the number of active threads in the CBS, automatically adjusts based on workload demand. The dynamic thread size evaluating module 206 applies a trained AI model 116 to adjust the number of active threads within a permissible range. When the required TPS exceeds the incoming TPS, the dynamic thread size evaluating module 206 increases the active thread count by a deviation value (Δ). Conversely, when the average CBS response time surpasses a defined threshold or the required TPS is below the incoming TPS, the dynamic thread size evaluating module 206 decreases the thread pool size by the deviation value (Δ) to prevent overloading. The deviation value (Δ) is computed based on the difference between the current concurrent request count and the benchmarked maximum concurrent transaction requests count of the CBS 110.

The training module 208 trains an artificial-intelligence (AI) model using a plurality of historical and real-time parameters. The training parameters may include the current number of concurrent transaction requests, the current and average response times of the transactions, the required and achieved TPS values, and a thread utilization ratio. The trained AI model 116 thereby learns to predict optimal thread pool configurations and transaction forwarding strategies. For example, the training module 208 may use supervised learning where transaction success rates are used as feedback labels to improve prediction accuracy for future load conditions.

The transaction-initiating module 210 initiates transaction processing by forwarding transactions to the CBS 110 in accordance with the dynamic thread pool size and AI-driven predictions. The transaction-initiating module 210 interacts with the trained AI model 116 to determine whether new transactions can be safely introduced without breaching response-time limits or causing CBS 110 congestion. In some embodiment, when the CBS load exceeds a defined utilization ratio, the transaction-initiating module 210 temporarily holds new transactions in the primary queue until resources become available.

The processing zone detecting module 212 identifies and manages multiple processing zones for queued transactions. The processing zones may include a primary queue configured to receive all incoming transactions and release them in a First-In-First-Out (FIFO) sequence, a high-priority queue configured to transfer transactions that have exceeded a defined waiting-time percentage (for example, 60 % of their permissible lifetime) from the primary queue, and a dead queue configured to isolate transactions that have surpassed their permissible lifetime or failed multiple retry attempts. The processing zones priority handling for time-sensitive transactions reduces timeout risk and maintains overall transaction fairness.

The transaction executing module 214 executes and finalizes transactions by communicating the queued requests from the second processing zone to the CBS 110. The transaction executing module 214 validates each transaction for completeness and integrity before submission, monitors response acknowledgements from the CBS 110, and records execution results. In cases where a transaction fails or times out, the module triggers a retry or re-queuing mechanism to ensure successful completion without manual intervention.

In operation, the transaction queueing and forwarding server 108 operates in conjunction with the trained AI model 116 and CBS 110 to enable real-time, intelligent load management. The combined functioning of the modules ensures that transaction flow is dynamically optimized based on system performance, preventing CBS overloads and maintaining compliance with predefined response-time constraints.

For example, when a sudden spike in digital transaction requests occurs, such as during payroll processing or festival-season transactions, the trained AI model 116 predicts the increase and directs the dynamic thread size evaluating module 206 to increase the thread count. The transaction-initiating module 210 then forwards queued transactions at a controlled rate, maintaining CBS 110 stability. Once the load normalizes, the system gradually reduces the active thread count to its base configuration. The adaptive behaviour enhances throughput, minimizes transaction failure, and ensures the continuous availability of banking services.

Accordingly, the transaction queueing and forwarding server 108 provides several technical advantages, including AI-driven adaptive thread pool management, predictive load balancing, multi-zone queue prioritization, and compliance with system-defined response times. The system thereby enhances reliability, scalability, and operational efficiency of core banking systems under variable transaction volumes.

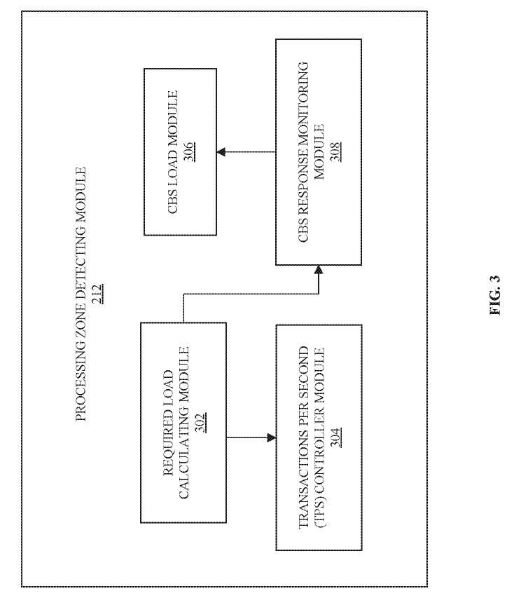

FIG. 3 illustrates a block diagram 300 of a processing zone detecting module 212, according to some embodiments herein. The processing zone detecting module 212 includes a required load calculating module 302, a transactions per second (TPS) controller module 304, a CBS load module 306, and a CBS response monitoring module 308. The modules cooperate to analyse CBS behaviour under different load conditions, predict performance limits, and dynamically align transaction throughput with CBS capacity.

The processing zone detecting module 212 forms a functional component of the transaction queueing and forwarding server 108, configured to compute, monitor, and regulate key operational parameters associated with the CBS 110. processing zone detecting module 212 ensures that the CBS operates within an optimal load threshold by continuously evaluating the system’s real-time performance indicators and adjusting transaction flow rates accordingly.

The required load calculating module 302 determines the estimated transaction load that needs to be processed within a predefined time interval based on incoming transaction requests, service-level agreements (SLAs), and CBS 110 operational constraints. The calculated required load value serves as a baseline for managing CBS 110 resource allocation and transaction scheduling.

The transactions per second (TPS) controller module 304 computes and regulates the rate of transactions forwarded to the CBS 110 from the transaction queueing and forwarding server 108. The transactions per second (TPS) controller module 304 dynamically adjusts the TPS value based on real-time feedback from the CBS load module 306 and the CBS response monitoring module 308, thereby ensuring that the system neither overloads nor underutilizes CBS processing capacity.

The CBS load module 306 continuously monitors the instantaneous and average system load of the CBS 110, including metrics such as the number of active threads, concurrent connections, and resource utilization percentages. The CBS load module 306 provides critical feedback to the required load calculating module 302 and TPS controller module 304 to maintain the CBS within a defined stability threshold and to prevent transaction failures due to resource saturation.

The CBS response monitoring module 308 measures and tracks real-time CBS response times and latency variations. The CBS response monitoring module 308 evaluates both the average and maximum response times of the CBS to identify technical performance degradations or bottlenecks. When the response time of the CBS exceeds a preconfigured limit, the CBS response monitoring module 308 signals the TPS controller module 304 to proportionally reduce transaction throughput until stable response performance is restored.

The modules collectively function to maintain equilibrium between incoming transaction demand and CBS processing capability. For instance, when the CBS response monitoring module 308 detects increased latency, the TPS controller module 304 reduces the forwarding rate, while the required load calculating module 302 recomputes the optimal transaction volume per interval. Conversely, when CBS load and response times return to nominal levels, the modules adaptively increase the throughput to enhance overall transaction efficiency. Through this coordinated control, the processing zone detecting module 212 ensures continuous CBS performance stability, prevents overload-related failures, minimizes transaction rejections and timeouts, and enhances overall transaction reliability.

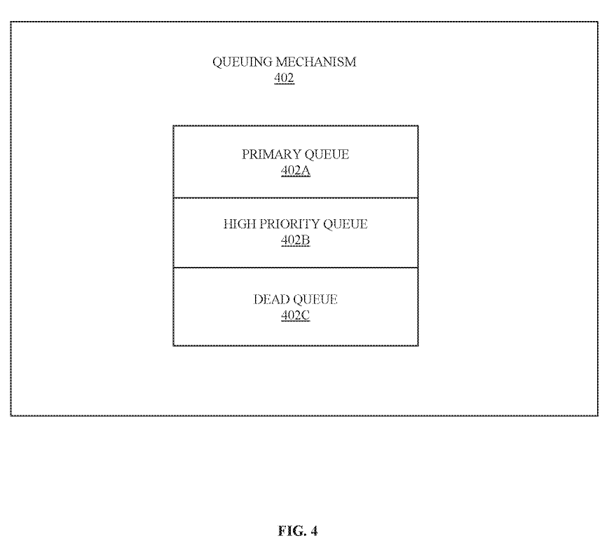

FIG. 4 illustrates a detailed block diagram of a queuing mechanism of the transaction queueing and forwarding server 108, according to some embodiments herein. The queuing mechanism 402 includes a primary queue 402A, a high priority queue 402B, and a dead queue 402C. The queuing mechanism 402 is configured to manage, prioritize, and control the flow of transaction requests before forwarding the transactions to the CBS.

The primary queue 402A is configured to receive all incoming transactions and temporarily store them before being released to the CBS for processing. The release of transactions from the primary queue 402A is performed in a controlled manner based on a dynamically determined thread pool size of the CBS, thereby ensuring optimal utilization of CBS resources and avoiding overload conditions.

Transactions residing in the primary queue 402A are continuously monitored with respect to their permissible lifespan. When a transaction has spent more than a predetermined percentage, for example sixty percent (60%) of its permissible lifespan, within the primary queue 402A, such a transaction is automatically promoted to the high priority queue 402B. The high priority queue 402Bis configured to hold transactions that require immediate or expedited processing. Transactions within the high priority queue 402B are arranged in descending order of priority, wherein the priority may be determined based on one or more time-sensitive parameters such as transaction type, amount, customer category, channel, merchant category code (MCC), or any other system-defined attribute.

If a transaction exceeds its entire permissible lifespan while remaining unprocessed in either the primary queue 402A or the high priority queue 402B, the transaction is transferred to the dead queue 402C. The dead queue 402C is configured to isolate expired transactions from active transaction flows. Transactions stored in the dead queue 402C are processed separately in order to prevent such expired transactions from burdening the CBS or affecting active transaction throughput.

Accordingly, the queuing mechanism ensures an organized and adaptive queuing mechanism that maintains compliance with system-defined maximum response times while optimizing CBS performance. By dynamically managing the movement of transactions between the primary queue 402A, high priority queue 402B, and dead queue 402C, the transaction queuing and forwarding server 108 effectively enables seamless, efficient, and failure-resistant transaction executions.

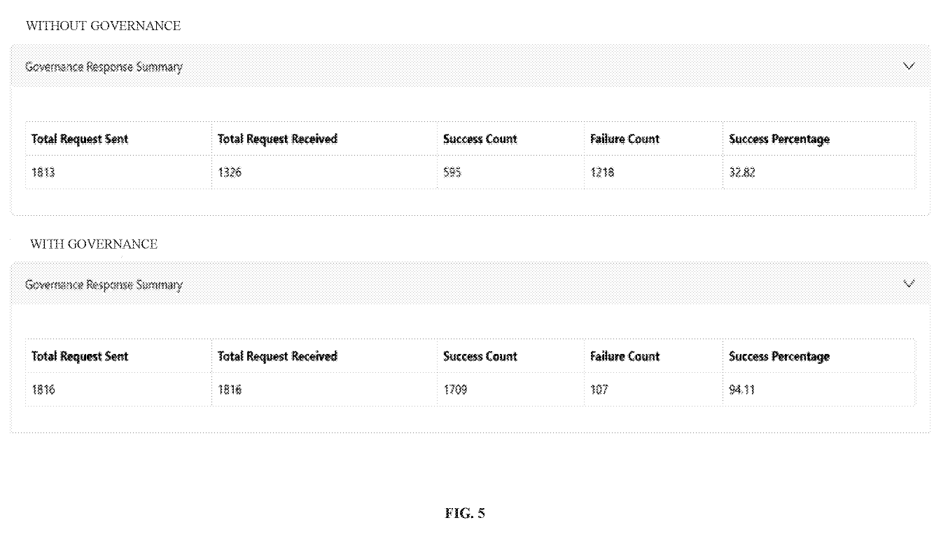

FIG. 5 illustrates a comparative governance response summary showing transaction processing performance without governance and with governance, according to some embodiments herein. The figure illustrates a comparative governance response summary of a transaction processing system operating without transaction governance and with transaction governance enabled. In the without-governance scenario, the system exhibits a significant disparity between the total number of transaction requests sent and the number of requests successfully processed, resulting in a high failure count and a relatively low transaction success rate, indicative of processing delays, system overload, or technical timeout conditions under high transaction volume. In contrast, when transaction governance is applied, the number of transaction requests sent closely corresponds to the number of requests received, with a substantially higher success count and a significantly reduced failure count, thereby yielding a markedly improved success percentage. The comparison demonstrates that the application of transaction governance effectively regulates incoming transaction volume, improves resource utilization, reduces transaction failures caused by congestion or timing constraints, and enhances overall system reliability and transaction success performance.

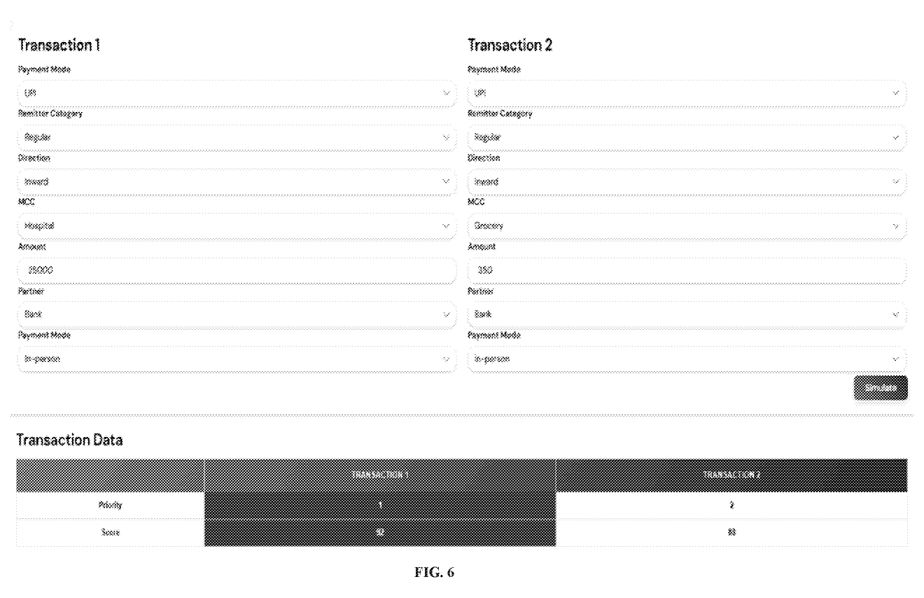

FIG. 6 illustrates an example user interface for configuring multiple transaction parameters and generating transaction priority scores for transaction governance, according to some embodiments herein. The figure illustrates an exemplary graphical user interface (GUI) configured to receive transaction-related parameters for a plurality of transactions and to generate corresponding transaction priority and scoring data for transaction governance and routing decisions. The GUI enables side-by-side configuration of a first transaction and a second transaction, with input fields for specifying transaction parameters including a payment mode, a remitter category, a transaction direction, a merchant category code (MCC), a transaction amount, a partner or financial institution identifier, and a transaction context, which collectively define characteristics of each incoming transaction request. The interface further includes a simulation control configured to initiate processing of the configured transaction parameters, wherein, upon simulation, the system generates transaction-related output data displayed in a transaction data section of the GUI. As illustrated, each transaction is assigned a priority level and an associated score, the priority level indicating a relative ordering for processing or routing and the score representing a computed value derived from one or more transaction parameters and system performance metrics. The GUI thereby enables dynamic evaluation, comparison, and governance of multiple incoming transaction requests, supporting intelligent transaction offloading, load management, and reduction of transaction failures caused by system overload or technical timeout conditions.

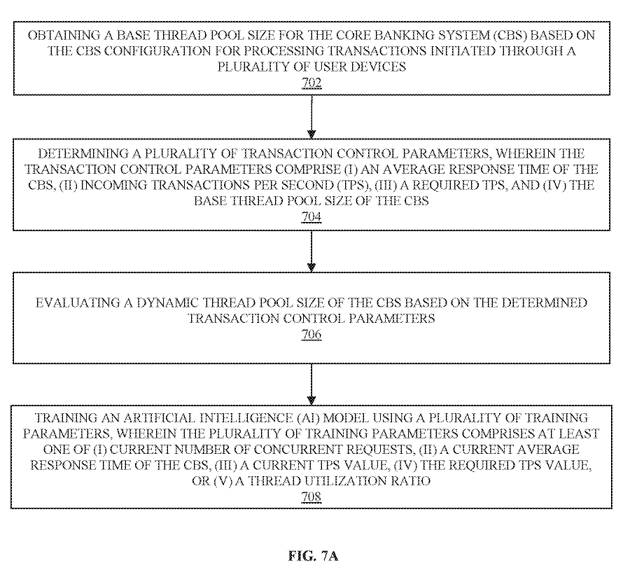

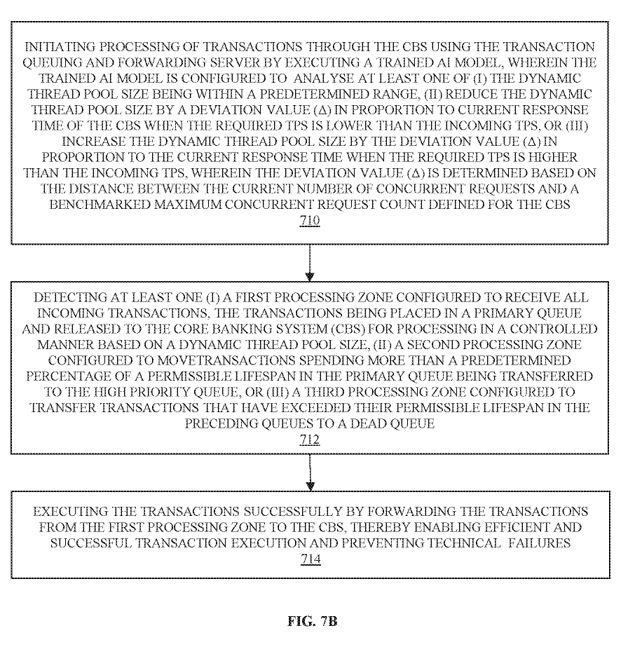

FIGS. 7A-7B is a flow diagram that illustrates an automated system for transaction queueing and forwarding to a core banking system to prevent technical failures according to some embodiment herein. At step 702, the method includes obtaining a base thread pool size for the core banking system (CBS) based on the CBS configuration for processing transactions initiated through a plurality of user devices. At step 704, the method includes determining a plurality of transaction control parameters, wherein the transaction control parameters comprise (i) an average response time of the CBS, (ii) incoming transactions per second (TPS), (iii) a required TPS, and (iv) the base thread pool size of the CBS. At step 706, the method includes evaluating a dynamic thread pool size of the CBS based on the determined transaction control parameters. At step 708, the method includes training an artificial intelligence (AI) model using a plurality of training parameters, wherein the plurality of training parameters comprises at least one of (i) current number of concurrent transaction requests, (ii) a current average response time of the CBS, (iii) a current TPS value, (iv) the required TPS value, or (v) a thread utilization ratio. At step 710, the method includes initiating processing of transactions through the CBS using the transaction queuing and forwarding server by executing a trained AI model, wherein the trained AI model is configured to analyse at least one of (i) the dynamic thread pool size being within a predetermined range, (ii) reduce the dynamic thread pool size by a deviation value (Δ) in proportion to current response time of the CBS when the required TPS is lower than the incoming TPS, or (iii) increase the dynamic thread pool size by the deviation value (Δ) in proportion to the current response time when the required TPS is higher than the incoming TPS, wherein the deviation value (Δ) is determined based on the distance between the current number of concurrent transaction requests and benchmarked maximum concurrent transaction requests count defined for the CBS. At step 712, the method includes detecting at least one (i) a first processing zone configured to receive all incoming transactions, the transactions being placed in a primary queue and released to the Core Banking System (CBS) for processing in a controlled manner based on a dynamic thread pool size, (ii) a second processing zone configured to move transactions spending more than a predetermined percentage of a permissible lifespan in the primary queue being transferred to the high priority queue, or (iii) a third processing zone configured to transfer transactions that have exceeded their permissible lifespan in the preceding queues to a dead queue. At step 714, the method includes executing the transactions successfully by forwarding the transactions from the second processing zone to the CBS, thereby enabling efficient and successful transaction execution and preventing technical failures.

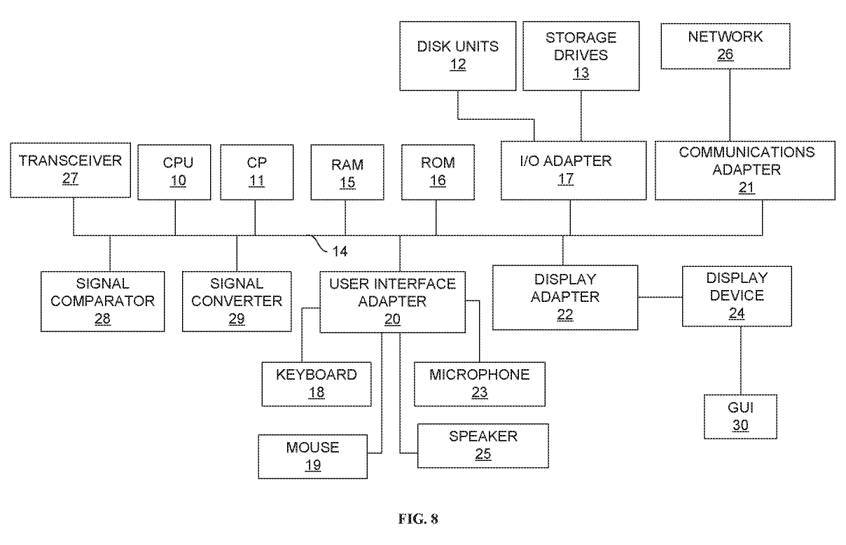

A representative hardware environment for practicing the embodiments herein is depicted in FIG. 8, with reference to FIGS. 1 through 7A-7B in accordance with the embodiments herein. This schematic drawing illustrates a hardware configuration of a personalized apparel warping generation server 106/computer system/ computing device in accordance with the embodiments herein. The system includes at least one processing device CPU 10 that may be interconnected via system bus 14 to various devices such as a random-access memory (RAM) 15, read-only memory (ROM) 16, and an input/output (I/O) adapter 17. The I/O adapter 17 can connect to peripheral devices, such as disk units 12 and program storage drives 13 that are readable by the system. The system can read the inventive instructions on the program storage drives 13 and follow these instructions to execute the methodology of the embodiments herein. The system further includes a user interface adapter 20 that connects a keyboard 18, mouse 19, speaker 25, microphone 23, and/or other user interface devices such as a touch screen device (not shown) to the bus 14 to gather user input. Additionally, a communication adapter 21 connects the bus 14 to a data processing network 26, and a display adapter 22 connects the bus 14 to a display device 24, which provides a graphical user interface (GUI) 30 of the output data in accordance with the embodiments herein, or which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope.

What is claimed is:

1. An automated system (100) for transaction queueing and forwarding to a core banking system (CBS) (110) to prevent technical failures, wherein the system comprises:
a memory (112);
a processor (114) communicatively connected to the memory (112) and configured to:
obtain a base thread pool size for the core banking system (CBS) (110) based on the CBS (110) configuration for processing transactions initiated through a plurality of user devices (102);
determine a plurality of transaction control parameters, wherein the transaction control parameters comprise (i) an average response time of the CBS (110), (ii) incoming transactions per second (TPS), (iii) a required TPS, and (iv) the base thread pool size of the CBS (110);
characterized in that,
evaluate a dynamic thread pool size of the CBS (110) based on the determined transaction control parameters;
train an artificial intelligence (AI) model using a plurality of training parameters, wherein the plurality of training parameters comprises at least one of (i) current number of concurrent transaction requests, (ii) a current average response time of the CBS (110), (iii) a current TPS value, (iv) the required TPS value, or (v) a thread utilization ratio;
initiate processing of transactions through the CBS (110) using the transaction queuing and forwarding server (108) by executing a trained AI model (116), wherein the trained AI model (116) is configured to analyse at least one of (i) the dynamic thread pool size being within a predetermined range, (ii) reduce the dynamic thread pool size by a deviation value (Δ) in proportion to current response time of the CBS (110) when the required TPS is lower than the incoming TPS, or (iii) increase the dynamic thread pool size by the deviation value (Δ) in proportion to the current response time when the required TPS is higher than the incoming TPS, wherein the deviation value (Δ) is determined based on the distance between the current number of transaction concurrent requests and benchmarked maximum concurrent transaction requests count defined for the CBS (110);
detect at least one of (i) a first processing zone configured to receive all incoming transactions, the transactions being placed in a primary queue (402A) and released to the CBS (110) for processing in a controlled manner based on a dynamic thread pool size, (ii) a second processing zone configured to move transactions spending more than a predetermined percentage of a permissible lifespan in the primary queue (402A) being transferred to the high priority queue (402B), or (iii) a third processing zone configured to transfer transactions that have exceeded their permissible lifespan in the preceding queues to a dead queue (402C); and
execute the transactions successfully by forwarding the transactions from the second processing zone to the CBS (110), thereby enabling efficient and successful transaction execution and preventing technical failures.

2. The automated system (100) for transaction queueing and forwarding to core banking system as claimed in claim 1, wherein a TPS controller of the transaction queuing and forwarding server (108) adjusts a transaction thread count proportionally to the thread utilization ratio of the CBS (110), wherein the thread utilization ratio being defined as a metric indicating a number of requests processed by a processing thread per unit time, and wherein adjustments are incrementally performed based on dynamic load on the CBS (110).

3. The automated system (100) for transaction queueing and forwarding to core banking system as claimed in claim 1, wherein the dynamic load on the CBS (110) is determined using the current response time and an average response time, wherein the current response time of the CBS (110) is measured as the interval between the reception of a transaction request and the completion of the corresponding response and the average response time of the CBS (110) is measured as the mean of the response times for a plurality of transaction requests processed by the CBS (110) over a predetermined time interval.

4. The automated system (100) for transaction queueing and forwarding to core banking system as claimed in claim 1, wherein the base thread pool size of the CBS (110) refers to a predefined number of threads allocated for transaction processing, and the dynamic thread pool size refers to the number of threads adjusted in response to the dynamic load on the CBS (110).

5. The automated system (100) for transaction queueing and forwarding to core banking system as claimed in claim 1, wherein a queue manager of the transaction queuing and forwarding server (108) is configured to prioritize transactions based on time-sensitive parameters and routes transactions from the second queue and the third queue, wherein the time-sensitive parameters comprise at least one of the (i) financial/non-financial, (ii) Merchant Category Code (MCC), (iii) transaction amount (iv) customer category, (v) channel-wise, (vi) inward /outward, (vii) channel-wise beneficiary bank performance, (viii) a financial technology entity, (ix) transaction mode (x) beneficiary type.

6. The automated system (100) for transaction queueing and forwarding to the core banking system as claimed in claim 1, wherein the AI model determines an optimal transaction forwarding, predicts a CBS (110) overload, and derives warning levels for queuing, and routes transactions to optimize throughput and minimize transaction failures dynamically.

7. The automated system (100) for transaction queueing and forwarding to a core banking system as claimed in claim 1, wherein the queuing mechanism utilizes a system-defined maximum transaction response time to maintain compliance while offloading CBS (110) resources, wherein the queuing mechanism comprising at least one of a primary queue, a high priority queue, and a dead queue, wherein the primary queue receives all incoming transactions and operates on a first-in, first-out (FIFO) basis, the high priority queue arranges transactions in descending order of priority, with equal priorities following FIFO and the dead queue operates on FIFO and stores failed or unprocessed transactions.

8. An automated method (100) for transaction queueing and forwarding to a core banking system to prevent technical failures, wherein the method comprises:
obtaining a base thread pool size for the core banking system (CBS) (110) based on the CBS (110) configuration for processing transactions initiated through a plurality of user devices (102);
determining a plurality of transaction control parameters, wherein the transaction control parameters comprise (i) an average response time of the CBS (110), (ii) incoming transactions per second (TPS), (iii) a required TPS, and (iv) the base thread pool size of the CBS (110);
characterized in that,
evaluating a dynamic thread pool size of the CBS (110) based on the determined transaction control parameters;
training an artificial intelligence (AI) model using a plurality of training parameters, wherein the plurality of training parameters comprises at least one of (i) current number of concurrent transaction requests, (ii) a current average response time of the CBS (110), (iii) a current TPS value, (iv) the required TPS value, or (v) a thread utilization ratio;
initiating processing of transactions through the CBS (110) using the transaction queuing and forwarding server (108) by executing a trained AI model (116), wherein the trained AI model (116) is configured to analyse at least one of (i) the dynamic thread pool size being within a predetermined range, (ii) reduce the dynamic thread pool size by a deviation value (Δ) in proportion to current response time of the CBS (110) when the required TPS is lower than the incoming TPS, or (iii) increase the dynamic thread pool size by the deviation value (Δ) in proportion to the current response time when the required TPS is higher than the incoming TPS, wherein the deviation value (Δ) is determined based on the distance between the current number of concurrent transaction requests and benchmarked maximum concurrent transaction requests count defined for the CBS (110);
detecting at least one of (i) a first processing zone configured to receive all incoming transactions, the transactions being placed in a primary queue (402A) and released to the CBS (110) for processing in a controlled manner based on a dynamic thread pool size, (ii) a second processing zone configured to move transactions spending more than a predetermined percentage of a permissible lifespan in the primary queue (402A) being transferred to the high priority queue (402B), or (iii) a third processing zone configured to transfer transactions that have exceeded their permissible lifespan in the preceding queues to a dead queue (402C); and
executing the transactions successfully by forwarding the transactions from the second processing zone to the CBS (110), thereby enabling efficient and successful transaction execution and preventing technical failures.

9. The automated method (100) for transaction queueing and forwarding to core banking system as claimed in claim 8, wherein a TPS controller of the transaction queuing and forwarding server (108) adjusts a transaction thread count proportionally to the thread utilization ratio of the CBS (110), wherein the thread utilization ratio is a metric indicating a number of requests processed by a processing thread per unit time, and wherein adjustments are incrementally performed based on dynamic load on the CBS.

10. The automated method (100) for transaction queueing and forwarding to core banking system as claimed in claim 8, wherein the dynamic load on the CBS (110) is determined using the current response time and an average response time, wherein the current response time of the CBS (110) is measured as the interval between the reception of a transaction request and the completion of the corresponding response and the average response time of the CBS (110) is measured as the mean of the response times for a plurality of transaction requests processed by the CBS (110) over a predetermined time interval.
